(19) United States
(12) Patent Application Publication
(10) Pub. No.: US 2005/0152337 A1
(43) Pub. Date: Jul. 14, 2005

(54) Apparatus for allowing handheld wireless devices to communicate voice and information over preexisting telephone lines

(75) Inventors: Leonard Wurtzel, Kochav Yair (IL); Edward Ehrlich, Jerusalem (IL); David Mandelzweig, Kochav Yair (IL)

Correspondence Address: MARSTELLER & ASSOCIATES, P O BOX 803302, DALLAS, TX, 75380-3302, US

(73) Assignee: Wireless Roots LTD., Kochav Yair (IL)

(21) Appl. No.: 10/757,665

(22) Filed: Jan. 14, 2004

(51) Int. Cl. H04L 12/66

(52) U.S. Cl. 370/352; 370/338; 370/463; 455/426.2

(57) ABSTRACT

Communication apparatus for interfacing between wired and wireless voice/data generating/receiving apparatuses and a physical telephone line of a communication network that comprises a telephone outlet, which is mounted within a wall of a building and includes first and second connecting means. These connecting means are electrically connected to each other and to the physical telephone line. The second connecting means allow connecting a wired telephone apparatus to the telephone line. A detachable module is designed to be completely embedded within the telephone outlet, whenever inserted into the outlet, mechanically fits into, and electrically adapted to cooperate with the outlet. The module has a wireless end and first and second wired ends, and provides wireless coupling between the voice/data generating/receiving apparatus and the telephone line by utilizing the wireless end and wired coupling between the module to the telephone line, which is obtained by utilizing the first wired end and the first connection means. The module comprises all the circuit components required for receiving and transmitting the wireless voice/digital information and, if required, to transform the format of the received voice/digital information into a format complying with a communication protocol suitable to be fed to the communication network. The first wired end of the module comprises electrical contacts for providing the circuit components power, which exists on the telephone line, and signal connectivity, and is capable of mating with the first connection means. The second wired end of the module is designed to be completely embedded within the module, and intermediates between a wired telephone apparatus and the telephone line.

### FIELD OF THE INVENTION

This invention relates to a communication apparatus, for transmitting to and receiving from a handheld device, wireless voice and data, whether digital or analog, over a telecommunication network, in particular a preexisting one such as a conventional telephone wiring system.

### BACKGROUND OF THE INVENTION

As communications technologies become more complex, there is a growing need for telephone communication to be more tightly coupled with data oriented devices, such as Personal Computers (PCs) and Personal Organizers or Personal Digital Assistants (PDAs). The PCs and PDAs contain phone address listings, scheduling information and personal databases that are essential for effective and enhanced communication.

Consumers are increasingly unwilling to accept less than full communication services and convenience while away from homes and offices. But while communications systems are providing more services, they are simultaneously becoming more complex. A communication consumer requires that a standard interface will allow him, or her, the benefit of communications from all locations (e.g. home, office, hotel, etc.).

While conventional solutions employ combinations of wired and wireless segments in a single network, they do not fully satisfy the necessary requirements of simplicity, efficiency and portability. For example, the kit disclosed in WO 01/80543 A2 is intended to be permanently attached to a wall, which is undesirable for structural, functional and economic reasons, since such a module could not be conveniently removed and used somewhere else. While this kit makes it possible to attach a data oriented device to an external communication system through existing lines, the user is still restricted to a limited number of fixed locations. In other words, the module and outlet that encase it do not provide a more universal solution, according to which there should be provided a detachable and portable module that could be easily coupled to, and removed from, a conventional jack, such as RJ11, that is connected to a telephone line. Such a detachable module could be marketed as a compact accessory device for voice/data generating/receiving apparatuses and would provide a user with an access point for his handheld device anywhere telephone access is available.

It is an object of the present invention to provide a detachable and portable module having a wired end that could be conveniently connected to, and removed from, a conventional telephone outlet that is an access point of a preexisting telephone system, and a wireless end that would allow a voice/data generating/receiving apparatus (e.g., Bluetooth, IrDA, Wi-Fi, etc. enabled PC, PDA or cellular phone) forwarding voice/data to, and receiving voice/data from, a telephone line, via the conventional outlet.

It is another object of the present invention to provide portable access to preexisting telephone systems for devices such as a PC, PDA or cellular phone, thereby providing the user with a uniform operational interface to different telephone systems having access points that could be geographically far apart from each other.

It is still another purpose of the invention to provide such a module that is entirely stand-alone, detachable, and powered by the voltage carried by preexisting telephone line(s), and which has no exterior components except for a connecting plug, conventional or not conventional, affixed to the surface of one of its walls.

It is still a further object of the invention to achieve the aforementioned purposes by the use of electronic components that are standard and readily available on the market.

It is yet another object of the invention to provide a wall mountable telephone outlet that is designed especially for fully housing the detachable module, and may replace a preexisting telephone outlet related to telephone wiring systems, or be added to telephone wiring systems.

It is yet another object of the invention to provide a wired telephone connection in the telephone outlet so that, if the telephone outlet replaces an existing conventional outlet, the previous wired telephone connection would be duplicated and available, especially when the module is removed.

It is still another object of the invention to provide a wired telephone connection in the detachable module, so that, if the module is plugged into a conventional telephone outlet, the original functionality of the conventional telephone outlet would still be available.

Other purposes and advantages of the invention will appear as the description proceeds.

### SUMMARY OF THE INVENTION

The present invention is directed to a communication apparatus for interfacing between wired and wireless voice/data generating/receiving apparatuses and a physical telephone line of a communication network. More specifically, the present invention is directed to a detachable module and to a related ‘house-like’ telephone outlet (hereinafter ‘telephone outlet’) with which said detachable module is intended to be, at times, mated.

Preferably, the detachable module has both a wired and a wireless link. It also has a connection to mate the detachable module both physically and electrically to either the telephone outlet or any other conventional telephone outlet. The wireless link allows wireless voice/data generating/receiving apparatuses (e.g., Bluetooth, IrDA, Wi-Fi, etc. enabled PC, PDA, cellular phone, etc.) to wirelessly forward voice/data to, and receive voice/data from, a physical telephone line via the conventional outlet, which can be found in most homes and public buildings. By “wireless link” it is meant that the data or voice information is carried from a source to a destination by waves, which could be of any convenient portion of the spectrum, for example, electromagnetic waves, light waves or sound waves, that propagate from the said source to the said destination. For example, Radio Frequency (RF) transmission can be used, which complies with, e.g., IEEE802.11. Other examples may be Infrared or audio or inaudible based communication. The wired link of the detachable module is designed to be completely embedded within the detachable module, and it serves to intermediate between a wired telephone apparatus and the telephone line, thus duplicating and maintaining the original functionality of the jack of the conventional outlet which has been connected to the module. Thus, a wired telephone apparatus could be conveniently connected to, and removed from the wired link.

The telephone outlet is intended to be essentially completely mounted within a wall, replacing a preexisting conventional wall outlet related to telephone wiring systems, or added to telephone wiring systems, and the detachable module is designed to be essentially completely embedded within the telephone outlet, and electrically connected with its first wired end, via the telephone outlet, to a physical telephone line of the preexisting telephone wiring system. A standard wired link of the telephone outlet serves to intermediate between a wired telephone apparatus and the telephone line, thus duplicating and maintaining the original functionality of the conventional outlet that has been replaced by the telephone outlet.

According to an aspect of the present invention, the detachable module may be operatively connected, without any mechanical or electrical modifications, to a telephone line by connecting the corresponding wired end of the detachable module to a conventional telephone outlet (i.e., jack/plug) that is connected to the telephone line.

Preferably, the module is coupled to the telephone outlet by being inserted into it, and, to permit this, the telephone outlet is open and is typically, though not necessarily, structured as a rectangular box with an open side.

Preferably, the coupling is accomplished by introducing the module into the telephone outlet. Still more preferably, guiding means are provided in the telephone outlet and the module, to guide the insertion of the module into the telephone outlet. For example, the guiding means may be ‘rib-and-groove’, wherein ‘rib’ means being e.g. provided on the bottom and top of the telephone outlet and ‘groove’ means being correspondingly provided on the bottom and top of the module. Different guiding means, however, could easily be provided by skilled persons.

Preferably, the telephone outlet includes a first connection means for providing to the detachable module, via its first wired end, the required electrical connection to the physical telephone line (i.e., whenever inserted into the telephone outlet), and a second connection means for providing to a wired telephone apparatus an electrical connection to the same telephone line, thereby duplicating and maintaining the original functionality of the conventional outlet to which the module is attached. The second connection means may be an option.

It should be noted, that whenever the module is inserted into the telephone outlet, the first and second (if relevant, depending on the embodiment) wired ends of the module, are electrically connected in parallel with respect to each other, and with respect to the first and second connecting means of the telephone outlet, so that a voice call with multiple participants located at the telephone outlet may be performed, one participant of which may use the wireless connection and two participants of which may use wired telephones that are connected to the second wired end of the module and second connecting means of the related telephone outlet.

The present invention utilizes standard electronic components, which are readily available on the market, as well as known communication protocols. However, the present invention is characterized by the electronic circuits and components being all encased in one, relatively small, detachable, removable apparatus, that may be easily plugged into, and easily disconnected from a connecting means, normally a conventional jack such as RJ11, by mating to the latter connecting means a corresponding plug that is externally affixed to a corresponding side wall of the detachable module, and provides the required electrical connectivity between the electronic circuits and components, encased by the detachable module, to the corresponding physical telephone line.

The present invention is further characterized by providing a novel combination that comprises the detachable module and the telephone outlet, which are mechanically adapted to each other, and which are electrically cooperating with one another. According to one embodiment of the present invention, the telephone outlet also includes connecting means (e.g., RJ11 jack) and electronic means for allowing the connecting of a signal cable of a (wired) telephone to the telephone line, and, thereby, the corresponding telephone line may still be utilized identically as it had been utilized before being replaced by the apparatus, or for an additional wired telephone, allowing multi-party participation from the same outlet during a voice call, if so desired.

The electronic circuits/components contained within the detachable module are responsible for processing the signals that convey relevant information. Therefore, the module preferably encompasses all the electronic circuits and components required for receiving a relatively high frequency or infrared signal, which is normally emitted from a voice/data generating/receiving apparatus. The relatively high frequency or infrared signal carries voice or digital information according to a first voice/data protocol. Therefore the module comprises also electronic components for transforming the voice or digital information from the first voice/data protocol, or format, into a second voice/data protocol, or format, and vice versa, and for receiving low-frequency analog signals (e.g., voice) from a wired telephone, or from other low-frequency analog generating/receiving apparatus, and feeding the signals directly to the preexisting telephone system, or vice versa.

It is to be noted that when it is stated herein that a voice or data generating/receiving apparatus generates/receives voice or digital information, it is not meant that the information is digital in its initial nature, but, rather, it may initially be analog and converted to digital format, or bits, for transmission. The analog information can be extracted from the digital format. Thus, the radio or infrared waves, generated by corresponding voice/data generating apparatus (e.g., a Bluetooth, IrDA, Wi-Fi, etc. enabled PC, PDA, cellular telephone, etc.), which are modulated so as to carry voice or digital information in the form of binary digits according to a first protocol, are fed into a transceiver that is contained within the detachable module. The transceiver serially derives, from the radio waves, the binary digits, and forwards the serial binary digits to a component (e.g., a UART) that transforms the serial transmission of binary digits into corresponding parallel format, for allowing an efficient protocol conversion by a protocol converter (e.g., a DSP). The protocol converter converts the information from the first protocol to a second protocol, after which the protocol converter outputs corresponding binary digits or analog voice, forwarded via a direct line interface (e.g., a DAA), to the preexisting telephone access point. In the case of voice, the protocol converter converts the digital data (i.e., that represents the voice) back to analog signal, or, in the case of data, to various low-frequency tones, to comply with the method that is commonly used to transmit digital data across the PSTN. All these components are well known and readily available on the market, and they are powered by the voltage carried by the preexisting telephone line(s). Optionally, or alternatively, the protocol converter may be adapted to handle data and voice information that comply with other types of communication technologies, for example, the Asymmetric Digital Subscriber Line (ADSL) and the Integrated Services Digital Network (ISDN).

A telephone line, to which the novel communication apparatus is connected, may either transfer analog information, such as voice signals, or digital data. If there is no digital data traffic on the telephone line, up to three users may use the apparatus in the same telephone call/conversation, two of which by utilizing wired telephone apparatuses and the other by utilizing a wireless voice generating/receiving apparatus; i.e., the first user by utilizing the wireless end of the module (e.g., by using a Bluetooth, IRDA, Wi-Fi, etc. enabled cellular phone or PDA), the second user by utilizing the second connecting means of the telephone outlet (by using a wired telephone apparatus, and, according to the corresponding embodiment, the third user by utilizing the second wired end of the module (i.e., by using a wired telephone apparatus).

According to an aspect of the present invention, the detachable module and telephone outlet may replace a conventional base-station of a conventional cordless telephone system, and a corresponding, e.g., Bluetooth-enabled apparatus (e.g., a PDA) may replace the handset of the conventional base-station of the conventional cordless telephone system. The module and Bluetooth-enabled apparatus may, in fact, be considered as a new type of cordless telephone system, which is advantageous over the conventional cordless telephone system, since the new type of cordless telephone system does not require any cables nor an external power system for operation, and the new type of cordless telephone system could be very easily and conveniently moved from one location to another. In addition, the space, which is normally consumed by base-stations of conventional cordless telephone systems, could be spared that way.

The invention also comprises a method for interfacing between wired and wireless voice/data generating/receiving apparatuses and a physical telephone line of a communication network, which method comprises:
a) Mounting a telephone outlet in a wall, said outlet having an opening and a first jack/plug means (i.e., the first connection means) which provides an electrical connection to said telephone line. In addition, the outlet may also have a second jack/plug means (i.e., the second connection means) which may provide, to a wired telephone apparatus, an electrical connection to said telephone line;
b) Providing a detachable module that is adapted to be coupled to said telephone outlet, by being inserted into it, or coupled to any other conventional telephone outlet. The detachable module comprises projecting plug/jack contact means (i.e., the first wired end) adapted to be coupled to the first connection means of the telephone outlet, a wireless end, and, optionally, a second plug/jack contact means (i.e., the second wired end). The detachable module contains circuit means for transforming voice or digital information, which is fed to, or received from, the first connection means, into modulated, high frequency radio or infrared signal, or vice versa, and means for allowing feeding analog information to the first wired end of the module, or vice versa. The second wired end of the detachable module allows direct connection of a wired telephone apparatus to a physical telephone line, via the telephone outlet; and
c) Inserting the module into the telephone outlet, whereby to bring the first wired end of the module and the first connection means of the telephone outlet into electrical coupling.

### BRIEF DESCRIPTION OF THE DRAWINGS

In the drawings:

FIG. 1 is a perspective view of a telephone outlet according to the most preferred embodiment of the present invention;

FIGS. 2(a), (b) and (c) are respectively a front view of the telephone outlet, showing its inside, a vertical cross-section of FIG. 2(a), taken on the plane “bb” looking downwards, and a vertical cross-section of FIG. 2(a) taken on plane cc looking in the direction of the arrows;

FIG. 3 is a perspective view from the back of a module according to an embodiment of the present invention;

FIG. 4 is a schematic vertical cross-sectional view of the module of FIG. 3 exploded in two parts;

FIG. 5 is a schematic vertical cross-section of FIG. 4 taken on plane V-V looking in the direction of the arrows;

FIG. 6 is a schematic block diagram generally illustrating the operation of the apparatus according to the most preferred embodiment of the present invention;

FIGS. 7a and 7b are schematic illustrations of alternative coupling/decoupling mechanisms for coupling/decoupling the module to/from the telephone outlet, according to embodiments of the present invention; and

FIGS. 8a and 8b schematically illustrate hinged doors, which close to protect the inner space of the telephone outlet whenever there is not any module residing therein, according to an embodiment of the present invention.

### DETAILED DESCRIPTION OF PREFERRED EMBODIMENTS

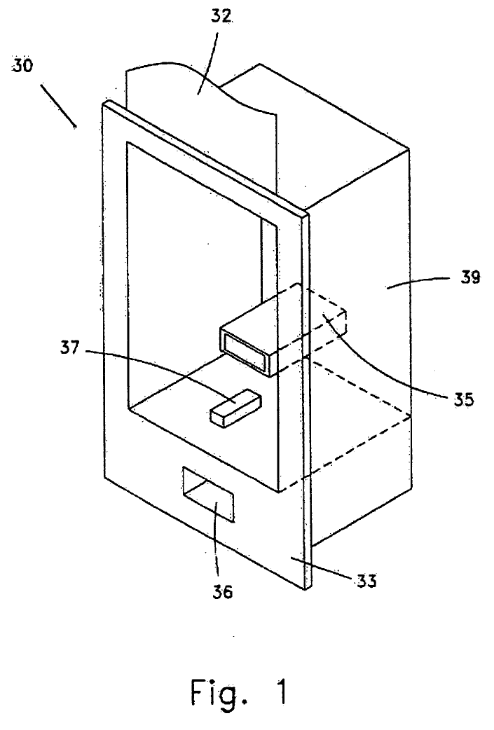

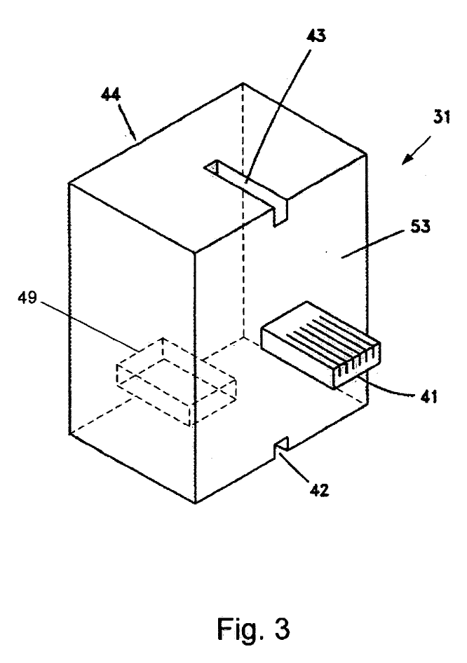

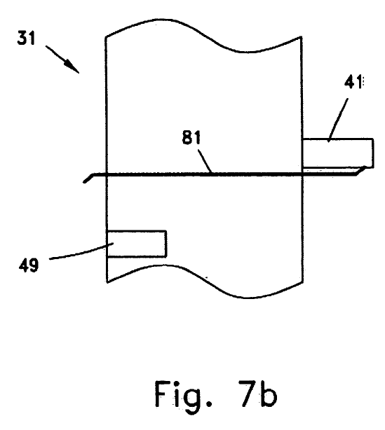

FIGS. 1 to 5 structurally illustrate the apparatus according to the most preferred embodiment of the invention. The housing part of the apparatus (i.e., the telephone outlet) is intended to be installed in a wall of a room in which voice/data generating/receiving apparatuses are to be used. The apparatus comprises a telephone outlet 30 (FIG. 1) and a detachable module 31 (FIG. 3), which are coupled as will be described. Embodiments of coupling/decoupling mechanisms, for coupling/decoupling the module to/from the telephone outlet, are schematically illustrated in FIG. 7a and FIG. 7b. However, as explained, operation of the module (31) does not require any housing at all, as it could be simply coupled to a conventional (telephone) jack of, e.g., a conventional wall telephone outlet. The telephone outlet serves as a convenient and aesthetic “docking station” for the module in locations frequently used.

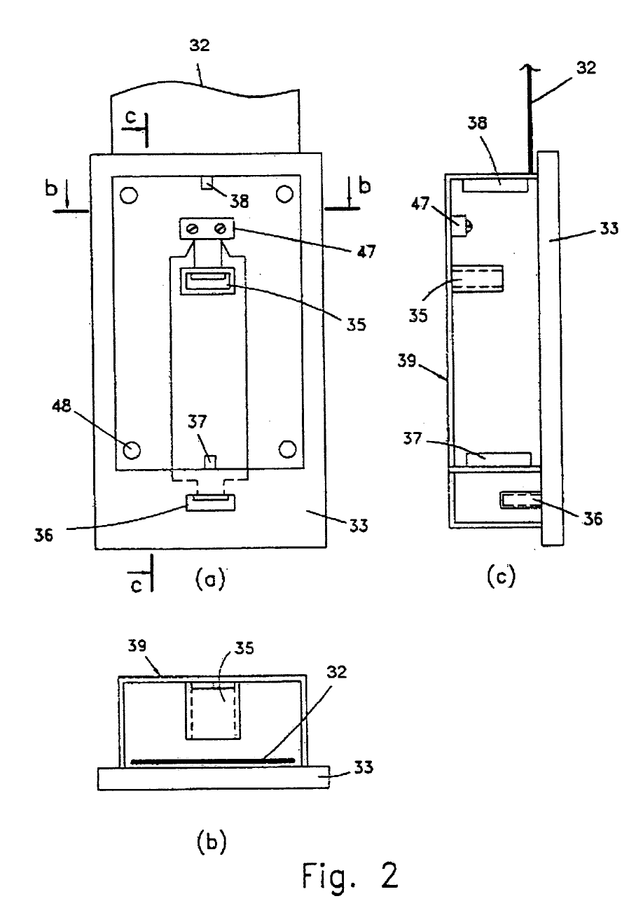

Telephone outlet 30 is seen in perspective view in FIG. 1, in front view in FIG. 2(a), in horizontal cross-section in FIG. 2(b), and in vertical cross-section in FIG. 2(c). It is shown as a rectangular box open at the front, by “front” it is intended herein the surface nearest to the inside of the room. The telephone outlet could have other shapes, as long as it is adapted to receive the detachable module encasing all the necessary processing circuits/components. Telephone outlet 30 is intended to be completely enclosed in a recess formed in a wall (not shown), except for the outer frame 33 that rests against the surface of the wall. Frame 33 is rigidly connected to a box-like backing 39 (best seen in FIG. 2). Telephone outlet 30 includes jacks 35 and 36 that are both electrically connected to terminal 47 (FIG. 2a), to which a telephone line of the communication system could be connected. Telephone outlet 30 includes two guide ribs 37 and 38, only one of which, rib 37, is visible in FIG. 1, while rib 38 is located on the underside of the top of telephone outlet 30. Reference numeral 48 designates four holes that allow securing the telephone outlet (i.e., by use of screws, not shown, passing there through) to the building wall within which the telephone outlet is to be mounted.

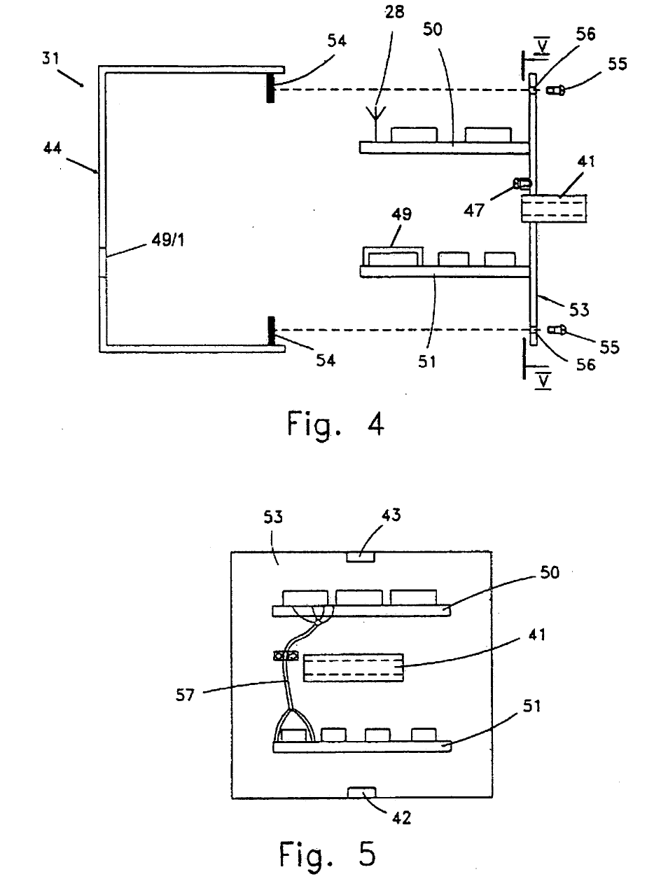

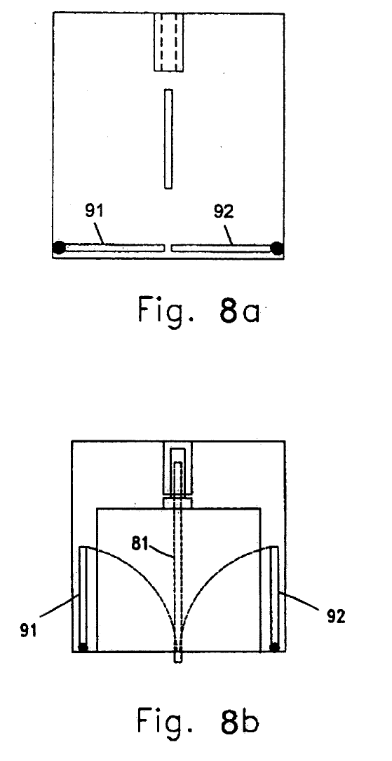

Detachable module 31 has a connection 41 that physically and electrically mates with connection 35 of telephone outlet 30, a wired link 49 (an option, and best seen in FIG. 7b) and two slots 42 and 43. Telephone outlet 30 has matching ribs 37 and 38 (FIG. 2c). When module 31 is inserted into telephone outlet 30, slots 42 and 43 engage ribs 37 and 38 and precisely guide the module 31, so that plug 41 will exactly penetrate into jack 35 of telephone outlet 30. When the insertion of module 31 into telephone outlet 30 has been completed, the outer surface 44 of the module (see FIG. 4) essentially fills the opening of frame 33 and all that is visible from the outside is frame 33, the opening of jack 36, the opening of jack 49 and surface 44. A removable or retractable cover 32 (FIG. 2c) may be provided to protect/hide the inside of the telephone outlet when module 31 is not inserted into telephone outlet 30. The specific removable cover 32 is shown only for illustration. Of course, other types of removable, or retractable, covers may be used, which have different mechanical arrangements. For example, the telephone outlet may have a cover that is constructed as hinged doors, as schematically shown in FIGS. 8a and 8b (reference numerals 91 and 92, in “Closed” and “Open” states, respectively).

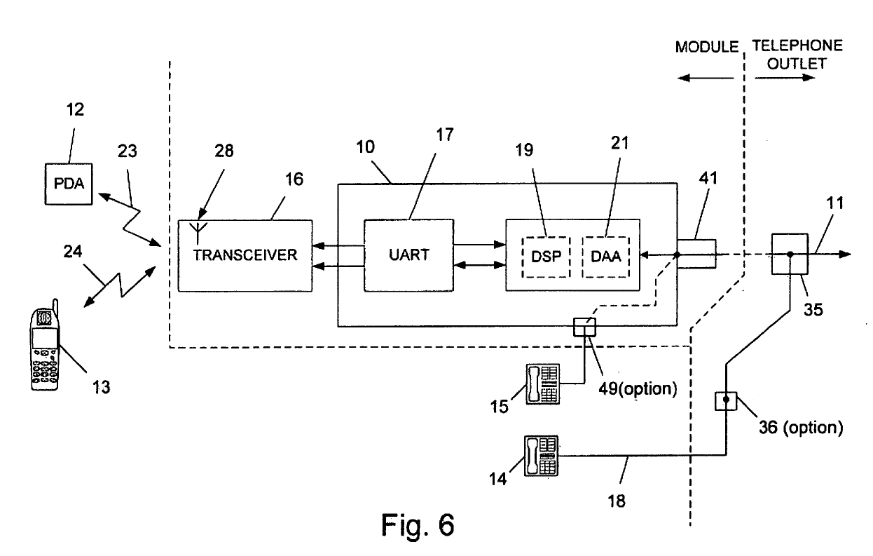

The structure of detachable module 31 is schematically illustrated in FIGS. 4 and 5. FIG. 4 is a schematic, exploded vertical cross-section of the module, taken on the plane adjacent to one of its side walls, in which a box-like housing is shown at 44 as separate from the back wall 53 of detachable module 31 which supports all the operative components, schematically indicated as supported on plates 50 and 51, which could be electronic Printed Circuit Boards (PCBs). Housing 44 has two ribs 54. Correspondingly, wall 53 is provided with screws 55. Once the front wall 53 with its attachments has been introduced into housing 44, said wall comes into contact with said ribs 54 and is attached to them by inserting screws 55 through opening 56 and screwing them into said ribs. The second wired end 49 of detachable module 31 may be mounted on, e.g., PCB 51, and accessed (i.e., by a wired telephone apparatus) through opening 49/1.

FIG. 5 is a cross-section of the assembled module taken on the plane adjacent to the front wall 53 and indicated as VV in FIG. 4. Wiring connection 57 is schematically shown for completing the electrical circuit between the components carried on PCB 50 and those carried on PCB 51.

As has been said, the operative, generally electronic, components carried by module 31, mounted on PCBs 50 and 51 in the embodiment illustrated, are known per se and available on the market. For instance, a transceiver complying with the “Bluetooth” telecommunications specification, could be, e.g., the MK7120 chip with its integrated antenna (manufactured by OKI). Alternatively, the transceiver could comply with the IRDA standard (e.g., RPM851A chip, manufactured by ROHM), which is the international standard for hardware and software used in infrared communication links. Alternatively, the transceiver could comply with the Wi-Fi (“wireless fidelity”) communication specification (e.g., the BCM2051/BCM4301 chipset, manufactured by Broadcom), which is the popular term for a high-frequency wireless local area network (WLAN). The remaining primary components, i.e., the UART, DSP and DAA, could be discrete components or, alternatively, one module could be utilized, for example the advanced TMS320C54CST modem chipset (manufactured by Texas Instrument), which is capable of performing the tasks of the UART, DSP and the DAA module.

Of course, the detachable module may be mechanically and electrically adapted to allow establishing a wired connection between USB-OTG, or the like, enabled apparatuses and the detachable module, for allowing the said USB-OTG, or the like, enabled apparatuses to utilize the voice/data modem capabilities of the said detachable module.

It should be understood that a connection between a first and a second electrical element, such as wires, that is described as comprising a plug attached to the first element and a jack attached to the second element, is equivalent to a connection comprising a jack attached to the first element and a plug attached to the second element. The expression “jack/plug” has been used hereinbefore and will be used in the claims to recite an element that is preferably a jack but may equally be a plug, while the expression “plug/jack” has been used hereinbefore and will be used in the claims correspondingly to recite an element that is preferably a plug but may equally be a jack.

It should also be understood that electrical connections may be effected by means of devices different from plugs and jacks, even transmitting signals by radiation, but equivalent as to operation, and that these operational equivalent components are intended to be included in the claims, though not specifically listed.

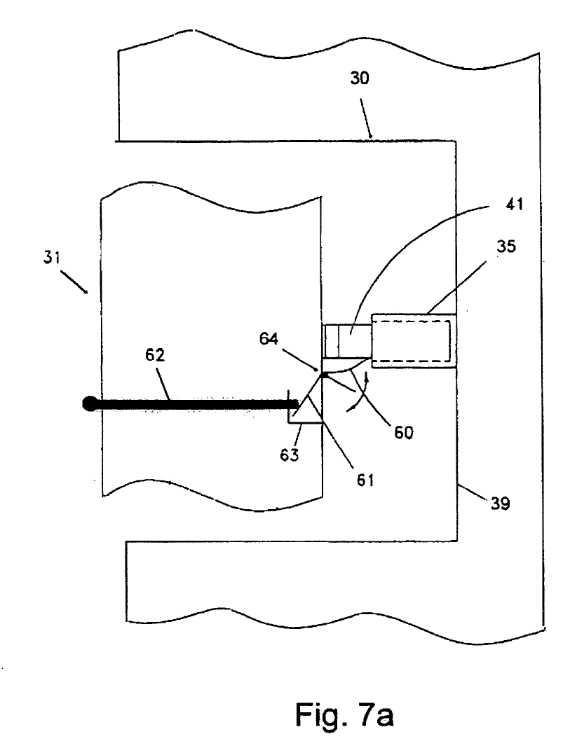

A functional diagram of the apparatus, according to the most preferred embodiment of the invention, is given in FIG. 6. The voice/data generating/receiving apparatus which is typically used is: a Bluetooth, IrDA, Wi-Fi, etc. enabled PDA 12 or a Bluetooth, IrDA, Wi-Fi, etc. enabled cellular telephone 13, which emit radio or optical waves carrying digitized voice or digital information. The digital information could be related to, e.g., data packets or Voice over IP (VoIP), which refers in general to IP telephony, and more specifically to voice delivered using the Internet Protocol.

In FIG. 6, PDA 12 and cellular telephone 13 generate/receive digital signals, complying with a first communication protocol/format, in the form of binary digits that are serially carried by high-frequency radio or optical waves (schematically indicated at 23 and 24, respectively) to/from transceiver 16, which is schematically indicated as provided with internal antenna 28. Transceiver 16 extracts, or derives, from the received radio waves (one might say, reads the signals as) the binary digits, which are then passed through voice/data modem 10, which comprises UART 17, DSP 19 and DAA 21, into telephone line 11 of a preexisting telephone system (not shown), and jack 35, which is part of telephone outlet 30 (FIG. 1). In modem 10, UART 17 transforms the serial binary digits into corresponding parallel digital words, in order to allow efficient processing by DSP 19. For data, the processing may also include formatting the parallel digital words into digital words complying with a second communication protocol or, for analog voice, converting to a corresponding analog format. The new formatted voice/data is then output to the preexisting telephone system, via DAA 21. Through the preexisting telephone system it will reach a second terminal (not shown), and undergo reverse processing, depending on the apparatus to which the information, provided by, e.g., PDA 12 or cellular telephone 13, is intended.

Telephone 14 is electrically connected by signal cable 18 to jack/plug 36 (i.e., the second connecting means of telephone outlet 30, FIG. 1) which is internally connected (i.e., inside telephone outlet 30—see FIG. 6) to plug/jack 35 (i.e., the first connecting means of telephone outlet 30, FIG. 1). Transceiver 16 and voice/data modem 10 are both encased within the detachable module 31 disclosed in the current invention. As described hereinabove, module 31 may include a wired link 49, in addition to its connection 41, for providing electrical connection to (additional) wired telephone apparatus 15. Users that utilize telephones 13, 14 and 15 may simultaneously communicate with other users that are connected to other access points of the same telephone system, provided that module 31 is inserted into telephone outlet 30, which is coupled to a physical access point of the telephone system. Line 11 may be utilized, at a given time, either for communicating digital data or voice.

FIGS. 7a and 7b schematically illustrate alternative coupling/decoupling mechanisms for coupling/decoupling module 31 to/from telephone outlet 30, according to two embodiments of the present invention. FIG. 7a illustrates the stage of the introduction of the module 31 (only partially shown in the figure) into the outlet 30 (only partially shown in the figure) in which contact finger 60 is only partially inside socket 35. A leaf spring 61, or other suitable elastic element, is attached to contact finger 60 and will elastically bind contact finger 60 to jack 35, when the two are fully coupled, and only the tip of said spring protrudes from jack 35. When it is desired to extract the module from the telephone outlet, pressure should be exerted on the tip of the spring 61, so as to relieve the elastic pressure between contact finger 60 and jack 35. A particular means for doing this is shown in FIG. 7a, but this is only an embodiment and other means can be used. In FIG. 7a, an ‘L-shaped’ lever 61 is shaped and mounted so that it can rotate around pivot 64, and a rod 62 is mounted so that it can slide along its longitudinal axis in order to allow exerting pressure on the left hand side leg of lever 61, thereby allowing disconnecting plug/jack 41 from jack/plug 35, said rod (i.e., 62) being supported at its end e.g. by a support 63 of any convenient shape. While the module is introduced into the telephone outlet, L-shaped lever 61 is inactive. After the module has been fully introduced and when it is wished to extract it, rod 62 is pushed in the same direction in which the module has been introduced, viz. to the right, as seen in FIG. 7a, and it presses the outer tip of spring 60, flattening it and facilitating the extraction of the module.

FIG. 7b shows an alternative mechanism for coupling/decoupling the module to the telephone outlet. Contact finger 81 is an extended version of contact finger 60 (FIG. 7a) in a way that extended contact finger 81 extends beyond the front face of module 31, so that it can be handled essentially the same way as contact finger 60; i.e., pulling upwards the contact finger 81 will release connecting means 41 from its counter connector 35.

The above embodiments have been described by way of illustration only and it will be understood that the invention may be carried out with many variations, modifications and adaptations, without departing from its spirit or exceeding the scope of the claims.

1. Communication apparatus for interfacing between wired and wireless voice/data generating/receiving apparatuses and a physical telephone line of a communication network, comprising:
a) Telephone outlet, said outlet being mounted within a wall of a building and includes first and second connecting means, said first and second connecting means being electrically connected to each other and to said physical telephone line, said second connecting means allowing connecting a wired telephone apparatus to said telephone line; and
b) Detachable module, said module being designed to be essentially completely embedded within the telephone outlet, whenever inserted into said outlet, and mechanically fitted into, and electrically adapted to cooperate with, said outlet, and having a wireless end and first and second wired ends, said module providing wireless coupling between said voice/data generating/receiving apparatus and said telephone line, by utilizing said wireless end and wired coupling between said module to said telephone line, which is obtained by utilizing said first wired end and said first connection means, said module comprising all the circuit components required for receiving and transmitting the wireless voice/digital information and, if required, to transform the format of said received voice/digital information into a format complying with a communication protocol, or format, that is suitable to be fed to said communication network, and vice versa, said first wired end of said module comprising electrical contacts for providing to said circuit components power, which exists on said telephone line, and signal connectivity, and is capable of mating with said first connection means, said second wired end of said module being designed to be completely embedded within said module, and serving to intermediate between a wired telephone apparatus and said telephone line.

2. Communication apparatus according to claim 1 wherein the telephone outlet has an opening and the module is mechanically and electrically coupled to said outlet by being inserted into said outlet through said opening, the insertion being guided by guiding means that are part of said outlet and said module.

3. Communication apparatus according to claim 2, wherein the guiding means are rib-and-groove guides provided in the telephone outlet and in the module for guiding the insertion of said module into said outlet.

4. Detachable module according to claim 1, wherein said module includes circuit means for transforming voice or digital information into modulated, high frequency or infrared signal, and vice versa, a transceiver, a component that transforms the serial transmission into a parallel transmission, and vice versa, a DSP processor that transforms between communication protocols, and a direct line interface to the preexisting telephone wiring system.

5. Detachable module according to claim 1, wherein said module is utilized as a base-station in a cordless telephone system, while a corresponding voice or digital data generating/receiving apparatus being the handset of said cordless telephone system.

6. Detachable module according to claims 1, 4 or 5, wherein said module is operative by being coupled to a conventional telephone outlet.

7. Method for interfacing between wired and wireless voice/data generating/receiving apparatuses and a physical telephone line of a communication network, which method comprising:
a) Mounting a telephone outlet in a wall, said outlet having an opening and a first jack/plug means for providing an electrical connection to said telephone line, and a second jack/plug means for providing, to a wired telephone apparatus, an electrical connection to said telephone line;
b) Providing a detachable module that is adapted to be mechanically and electrically coupled to said telephone outlet, by being fully inserted into said telephone outlet, said detachable module comprising projecting plug/jack contact means adapted to be coupled to said first connection means of the telephone outlet, a wireless end, and a second plug/jack contact means, said detachable module containing circuit means for transforming voice or digital information, which is fed to, or received from, said first connection means, into modulated, high frequency radio or infrared signal, or vice versa, and means for allowing feeding analog information to said first wired end of said module, or vice versa, said second wired end of said detachable module allowing direct connection of a wired telephone apparatus to a physical telephone line, via said telephone outlet; and
c) inserting said module into said telephone outlet, thereby bringing said first wired end of said module and said first connection means of said telephone outlet into electrical coupling.

8. Method according to claim 7, in which the detachable module is coupled to a conventional telephone outlet.
